(19) United States
(12) Patent Application Publication
(10) Pub. No.: US 2021/0114630 A1
(43) Pub. Date: Apr. 22, 2021

(54) TRANSPORT REFRIGERATION UNIT ADAPTER FRAME FOR RAILWAY CAR INSTALLATION

(71) Applicant: Carrier Corporation, Palm Beach Gardens, FL (US)

(72) Inventors: Michael Stockbridge, Canastota, NY (US); Raymond L. Senf, JR., Central Square, NY (US)

(21) Appl. No.: 16/949,227

(22) Filed: Oct. 21, 2020

Related U.S. Application Data
(60) Provisional application No. 62/924,331, filed on Oct. 22, 2019.

(51) Int. Cl. B61D 17/04; B61D 27/00; B61D 3/00

(52) U.S. Cl. CPC B61D 17/041; B61D 3/00; B61D 27/00

(57) ABSTRACT

Disclosed is an adapter frame for attaching a transport refrigeration unit (TRU) to a railway car, the adapter frame having a window and a supporting section, the window having a rectangular shape, the supporting section extending from an edge of the window and comprising two or more truss members spanning from an edge of the window to a corresponding edge of the supporting section, wherein the adapter frame is configured for installation between the TRU and the railway car such that a distal end of a protruding evaporator section of the TRU protrudes into the window.

### CROSS REFERENCE TO A RELATED APPLICATION

The application claims the benefit of U.S. Provisional Application No. 62/924,331 filed Oct. 22, 2019, the contents of which are hereby incorporated in their entirety.

### BACKGROUND

Exemplary embodiments pertain to the art of installation of a transport refrigeration unit (TRU).

As urbanization continues to shift more people move into urban environments, there can be constant need for the transport of food and other perishable items in environmentally controlled conditions. In order to deliver fresh products from farm to table a portfolio of technologies may be employed. For example, trucks and trailers outfitted with TRU's allow for the transport of foodstuffs via roadway by providing environmentally controlled cargo space that can preserve their freshness and longevity.

Railway hauling can provide an energy efficient alternative to roadway transport for long distance hauling of goods. It is becoming increasingly common for a TRU to be installed directly onto a railway car in order to facilitate rail transport of refrigerated goods.

### BRIEF DESCRIPTION

Disclosed is an adapter frame for attaching a transport refrigeration unit (TRU) to a railway car, the adapter frame comprising: a window and a supporting section, the window having a rectangular shape, the supporting section extending from an edge of the window and comprising two or more truss members spanning from an edge of the window to a corresponding edge of the supporting section, wherein the adapter frame is configured for installation between the TRU and the railway car such that a distal end of a protruding evaporator section of the TRU protrudes into the window.

In addition to one or more of the above disclosed aspects or as an alternate when installed the distal end of the TRU extends past an interior surface of the railway car wall.

In addition to one or more of the above disclosed aspects or as an alternate wherein when installed the distal end of the TRU is flush with an interior surface of the railway car wall.

In addition to one or more of the above disclosed aspects or as an alternate wherein when installed the distal end of the TRU is does not extend past an interior surface of the railway car wall.

In addition to one or more of the above disclosed aspects or as an alternate further comprising a plurality of fastening features disposed on a surface of the adapter frame.

In addition to one or more of the above disclosed aspects or as an alternate wherein the fastening features comprise a combination of a threaded stud, a captured nut, a slot or opening for accepting a bolt, a weld stud, a flange, a tab, or a combination comprising at least one of the foregoing.

In addition to one or more of the above disclosed aspects or as an alternate further comprising a corner support fastened to a surface of the adapter frame, the corner support extending diagonally between two adjacent structural segments forming a corner.

In addition to one or more of the above disclosed aspects or as an alternate wherein the supporting section has a quadrilateral shape where a width dimension is larger than a height dimension and the corner support extends along a TRU side surface of the adapter frame, adjacent to a corner of the quadrilateral shape, from one side to an adjacent side of the supporting section.

In addition to one or more of the above disclosed aspects or as an alternate wherein the structural segments comprise quadrilateral cross-sectional shape.

In addition to one or more of the above disclosed aspects or as an alternate wherein the window comprises a width of 40 inches to 60 inches, a height of 8 inches to 20 inches.

In addition to one or more of the above disclosed aspects or as an alternate wherein the window comprises a width of 60 inches to 80 inches, a height of 40 inches to 60 inches.

In addition to one or more of the above disclosed aspects or as an alternate wherein the window aligns with an opening in a wall of the railway car.

Further disclosed is a method of installing a TRU onto a railway car comprising attaching an adapter frame onto the TRU using a plurality of fastening features disposed along a surface of the adapter frame to form a combined adapter frame and TRU, and attaching the combined adapter frame and TRU onto a railway car using a plurality of fastening features disposed along an opposing surface of the adapter frame thereby securing the TRU, adapter frame and railway car together.

In addition to one or more of the above disclosed aspects or as an alternate the method includes sealing a gap between the TRU and a railway car wall.

Further disclosed is a method of installing a TRU onto a railway car comprising attaching an adapter frame onto the railway car using a plurality of fastening features disposed along a surface of the adapter frame to form a combined adapter frame and railway car, and attaching the TRU onto the combined adapter frame and railway car using a plurality of fastening features disposed along an opposing surface of the adapter frame thereby securing the TRU, adapter frame and railway car together.

In addition to one or more of the above disclosed aspects or as an alternate the method includes sealing a gap between the TRU and a railway car wall.

### BRIEF DESCRIPTION OF THE DRAWINGS

The following descriptions should not be considered limiting in any way. With reference to the accompanying drawings, like elements are numbered alike:

FIG. 1 is a schematic view of a TRU.

FIG. 2 is an angled rear schematic view of a TRU.

FIG. 3 is a side schematic view of a TRU.

FIG. 4 is a schematic view of a TRU installed onto a trailer without an adapter frame.

FIG. 5 is a schematic view of a TRU installed onto a railway car without an adapter frame.

FIG. 6 is a schematic view of an adapter frame for attaching a TRU to a railway car.

FIG. 7 is a schematic view of an adapter frame for attaching a TRU to a railway car.

FIG. 8 is a schematic view of a TRU installed onto a railway car with an adapter frame.

FIG. 9 is a schematic of a method of installing a TRU onto a railway car using an adapter frame.

FIG. 10 is a schematic of a method of installing a TRU onto a railway car using an adapter frame.

### DETAILED DESCRIPTION

A detailed description of one or more embodiments of the disclosed apparatus and method are presented herein by way of exemplification and not limitation with reference to the Figures.

A transport refrigeration unit (TRU) is a refrigeration device configured to cool a cargo space by blowing air from the cargo space over a heat absorbing evaporator coil thereby cooling the air, and returning it to the cargo space. A TRU can be designed to meet a number of customer and application requirements, such as the outer physical envelope of the TRU. The shape and overall dimensions of a TRU must ensure that once installed on a trailer there is adequate clearance for powered truck operation and maintenance, e.g., turning, fueling, accessing truck compartments and/or maintenance items, and the like. In some cases, these requirements can limit the arrangement of components within the allotted volume for the TRU. The resultant TRU layout can include otherwise unnecessary protrusion into the trailer cargo space.

Unlike some trailers, railway cars are generally not subject to swing radii or other powered truck maintenance activities. Therefore the outer envelope of a refrigeration unit is less constrained in a railway car application in comparison to trailer application. However, when a TRU is installed flush to the side of a railway car, the air outlet of the TRU can protrude into the conditioned cargo space similar to a trailer installation. Due at least in part to commonality of shipping sizes (e.g. shipping pallets), any extension from the interior wall of a railway car into the conditioned cargo space can reduce the cargo payload (e.g., by an entire row of shipping pallets). Reduction in payload can have a correspondingly negative impact on shipping cost, speed, and capacity. To overcome at least this limitation an adapter frame for attaching a TRU to a railway car is disclosed.

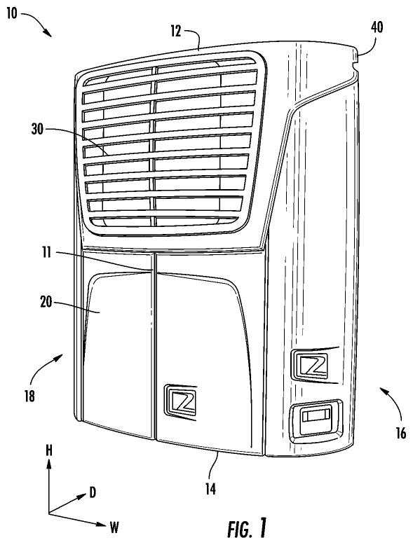

FIG. 1 is an illustration of a front view of a TRU 10. The TRU 10 has an outer enclosure 20, a condenser air inlet 30, and condenser air outlet 40. The TRU 10 can have additional interfaces for power, fuel (e.g., diesel, LPG, CNG, and the like), drain (e.g. condensate), control, communication, and the like. The TRU 10 can be any suitable TRU 10 having an air inlet/outlet configured for cooling the cargo space upon installation. For example, the TRU 10 can include a refrigeration unit such as the truck or trailer refrigeration systems manufactured by Carrier Corporation, Palm Beach Gardens, Fla., USA (e.g. Vector™ 8500, Vector™ 8600, Vector™ 8611, X4™ 7300, X4™ 7500, Supra® 660, Supra® 760, Supra® 860, Supra® 960, and the like).

The TRU 10 has a width measured along the w-dimension, a height measured along the h-dimension, and a depth measured along the d-dimension in the attached figures. The outside of the TRU 10 can be box shaped or can include aerodynamic features as the outside surface, such as curved edges. In any embodiment the TRU can include rounded or contoured edges, between the face 11 and top 12, bottom 14, and/or sides 16/18 of the TRU 10.

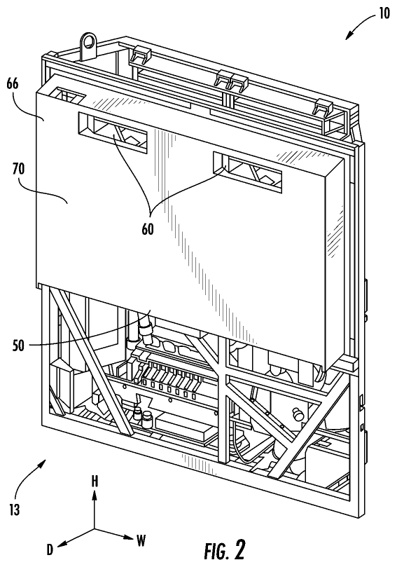

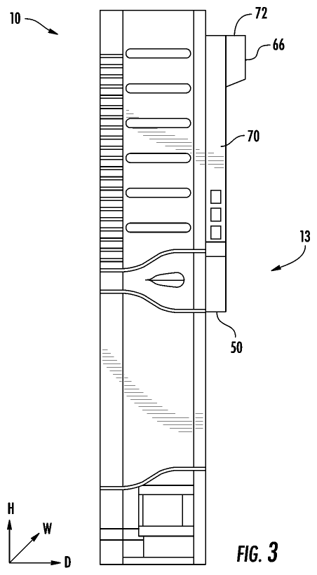

FIG. 2 is an illustration of a rear view of a TRU 10 with the outer enclosure 20 removed. The back side 13 (cargo side) of the TRU 10 can be flat, or have a surface shaped corresponding to the outside surface of a trailer. The TRU can have a protruding evaporator section 70 having the cargo air inlet 50 (which can be located for example under the protruding evaporator section 70) and one or more refrigerated cargo air outlets 60. As shown in FIG. 3, the protruding evaporator section 70 can include air outlet extensions 72 which can protrude further from the main body of TRU 10 than the protruding evaporator section 70 and can define a distal end 66 of the protruding evaporator section.

For trailer applications, the protruding evaporator section 70 can have a width (extending in the w dimension of the attached figures) of about 60 inches to about 80 inches, or about 65 inches to about 68 inches, or about 66.3 inches, a height (extending along the h dimension in the attached figures) of about 40 inches to about 60 inches, or about 44 inches to about 48 inches, or about 45.3 inches, and a protruding distance (extending along the d dimension of the attached figures) of about 1 inch to about 15 inches, or about 6 inches to about 10 inches, or about 8.2 inches.

For truck applications, the protruding evaporator section 70 can have a width of about 40 inches to about 60 inches, or about 48 inches to about 52 inches, or about 48.2 inches, a height of about 8 inches to about 20 inches, or about 10 inches to about 14 inches, or about 13 inches, or about 11.4 inches, and a protruding distance of about 1 inch to about 32 inches, or about 20 inches to about 32 inches, or about 28.8 inches, or about 24.8 inches. In an embodiment the protruding evaporator section 70 has a width of about 48.2 inches, a height of about 13 inches and a protruding distance of about 28.8 inches. In an embodiment the window 420 has a width of about 48.2 inches, a height of about 11.4 inches and a protruding evaporator distance of about 24.8 inches.

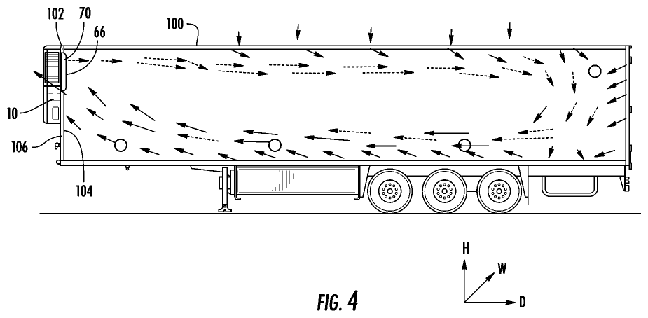

In truck/trailer applications the TRU 10 is flush mount to the outside surface of a trailer 100 as shown in FIG. 4. The trailer 100 is configured with an opening 102 for receiving the protruding evaporator section 70. Once installed the distal end 66 extends past the interior surface 104 of a trailer wall 106. Although undesirable, the size of the refrigeration unit components (e.g., compressor, evaporator coil, condenser coil, expansion device, plumbing, controller, and the like) and limited volume they may occupy outside the trailer can result in pushing protruding evaporator section 70 into the cargo space.

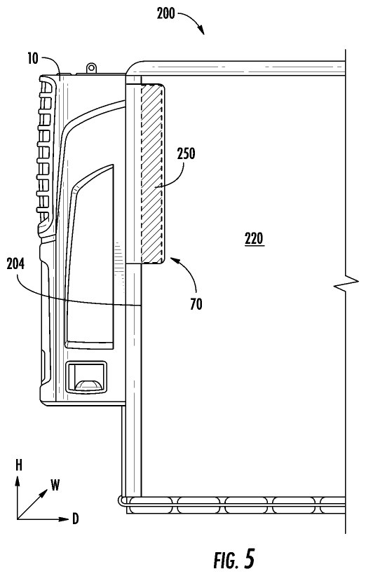

FIG. 5 is an illustration of a TRU 10 installed directly onto a wall of a railway car 200 without the use of the inventive adapter frame as disclosed herein. In this installation, the protruding evaporator section 70 extends past an interior surface 204 of the railway car 200 and creates an obstructed volume 250 (shaded area in FIG. 5) of the cargo volume 220 of the railway car 200. The size of the obstructed volume can be reduced through the use of the disclosed adapter frame 400, which can act to shift the protruding evaporator section 70 out of the opening 102 (in a negative direction along the d dimension in the attached figures) and away from the railway car cargo volume 220. Even small outward movement of the protruding evaporator section 70 from the cargo volume 220 can create significant advantages in payload capacity of the cargo volume 220. In some cases, this can allow for an entire row of shipping pallets to be added to a railway car's cargo volume 220.

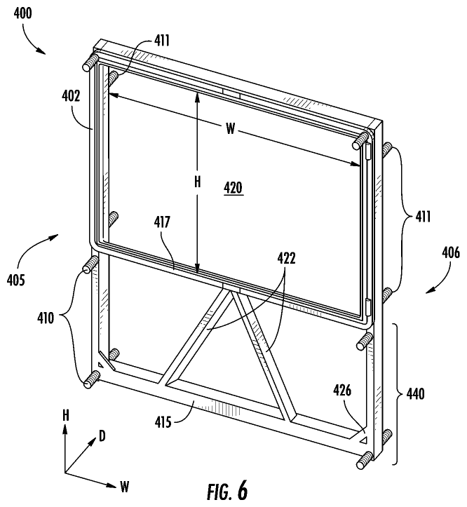

FIG. 6 is an illustration of an adapter frame 400 having a plurality of structural segments 402 fastened together to form a window 420 and a supporting section 440. The plurality of structural segments 402 can be any shape corresponding to the outside surface of a railway car 200 and the back side 13 of a TRU 10. The plurality of structural segments 402 can be formed from any suitably strong material capable of mounting and supporting a TRU 10 to a railway car 200. For example the structural segments 402 can be made of steel, aluminum, iron, alloys thereof, or a combination comprising at least one of the foregoing. In an example the structural segments 402 can be made of a polymer including for example polyethylene (PE), acrylonitrile butadiene styrene (ABS) polymer, high-density polyethylene (HDPE) polymer, and the like, and copolymers thereof. In an example the structural segments 402 can be made of a polymer composite, where the composite material includes a polymer resin such as a polymer previously mentioned and a woven, continuous, or chopped structural fiber, e.g., glass fiber, carbon fiber, aramid fiber, or the like.

The plurality of structural segments 402 can have any cross sectional shape, for example, the cross-sectional shape of any one or more segment of the plurality of structural segments can be quadrilateral (e.g., square, rectangular, and the like), triangular, other simple closed polygons, I-shaped, H-shaped, C-shaped, U-shaped, T-shaped, and the like. For example, the plurality of structural segments 402 can be linear, e.g., not having appreciable curvature in a given plane. The cross-sectional thickness T (extending along the t axis in the attached figures) of the adapter can

The plurality of structural segments 402 can be fastened in any suitable way to secure the segments and form the adapter frame 400. For example, the plurality of structural segments 402 can be welded (arc, ultrasonic, and the like), bolted or otherwise secured together to form the window 420 and the supporting section 440. In another example, the structural segments 402 can be formed integrally as a single unitary structure such as die cast, polymer molding, co-molding, multi shot molding, or other molding process. The window 420 can have any shape, for example it can have a shape corresponding to the outer dimensions of the protruding evaporator section 70 such that the protruding evaporator section 70 can slidably fit into the window 420 for purposes of installing and removing the TRU 10 from the adapter frame 400. For example, the window 420 can have a quadrilateral shape, such as square, rectangular, trapezoidal, and the like. The window 420 can optionally include additional framing extending from a front/rear surface (405/406) of the adapter frame 400 for added structural support of the window 420. Additional framing can be used for securing the protruding evaporator section 70 to the window 420. For example, the window 420 can be formed of steel box beam and an additional steel frame formed of steel having an L-shaped cross section welded to, and extending from, a front surface 405 of the adapter frame 400. The L-shape can provide a flange for fastening the TRU 10 or the railway car 200 to the adapter frame 400.

In an example, the window 420 is rectangular, the window has a width dimension W (extending along the w axis in the attached figures) that is larger than the height dimension H (extending along the h axis in the attached figures) and the supporting section 440 includes two or more truss members 422 spanning from an edge of the window 420 to a corresponding edge of the supporting section 440.

Corresponding to the dimensions of the protruding evaporator section 70 mentioned previously for trailer applications, the window 420 of the adapter frame 400 can have a width W of about 60 inches to about 80 inches, or about 65 inches to about 68 inches, or about 66.8 inches, a height H of about 40 inches to about 60 inches, or about 45 inches to about 48 inches, or about 46 inches, and a thickness (extending along the d dimension of the attached figures) of about 1 inch to about 16 inches, or about 2 inches to about 10 inches, or about 8.2 inches. In an embodiment the window 420 of the adapter frame 400 has a width of 66.8 inches, a height of 46 inches and a thickness of between 1 and 16 inches.

Corresponding to the dimensions of the protruding evaporator section 70 mentioned previously for truck applications, the window 420 of the adapter frame 400 can have a width W of about 40 inches to about 60 inches, or about 48 inches to about 52 inches, or about 49 inches, a height H of about 8 inches to about 20 inches, or about 10 inches to about 14 inches, or about 13 inches, or about 11.4 inches and a thickness (extending along the d dimension of the attached figures) of about 1 inch to about 32 inches, or about 1 inches to about 16 inches, or about 10 inches, or about 8 inches, or about 6 inches. In an embodiment the window 420 of the adapter frame 400 has a width of 49 inches, a height of 13.8 inches and a thickness of between 1 and 16 inches. In an embodiment the window 420 of the adapter frame 400 has a width of 49 inches, a height of 12.2 inches and a thickness of between 1 and 16 inches.

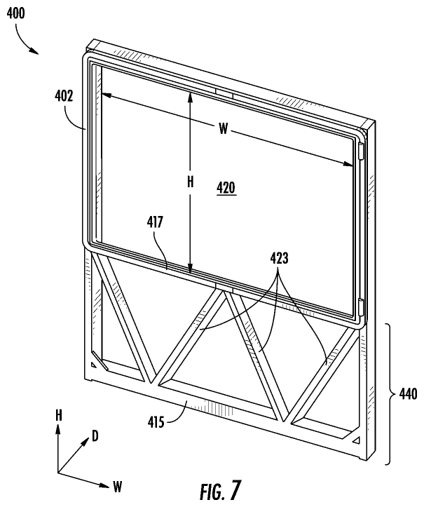

In another example, as shown in FIG. 7, the supporting section 440 can include a plurality of truss members 423. The plurality of truss members 423 can extend from a bottom structural segment 415 to a mid-spanning segment 417, which can also constitute an edge, and optionally the bottom edge of the window 420.

The adapter frame 400 can include a corner support 426 disposed between adjacent structural segments 402. The corner support 426 can be used to add rigidity to the adapter frame 400 and reinforce the structural segments 402 against deformation.

The adapter frame 400 can include TRU side fastening features 410 for securing the adapter frame 400 to a TRU 10. The adapter frame 400 can include rail car side fastening features 411 for securing the adapter frame 400 to a railway car 200. The TRU side fastening features 410 can be disposed along one face of the adapter frame 400, for example, the front surface 405 of the adapter frame 400. The rail car side fastening features 411 can be disposed on an opposing side of the adapter frame 400, for example the rear surface 406. The TRU side fastening features 410 and the rail car side fastening features 411 can be any suitable mechanical fastener, for example a threaded stud, a captured nut, a slot or opening for accepting a bolt, a weld stud, a flange, a tab, or a combination including at least one of the foregoing. For example, the adapter frame 400 can include a threaded stud extending from a front surface 405 of the adapter frame 400, along the depth dimension, for inserting into a corresponding opening on the TRU 10 which can accept the treaded stud and allow for movement of a washer and/or nut to securely fasten the adapter frame 400 to the TRU 10.

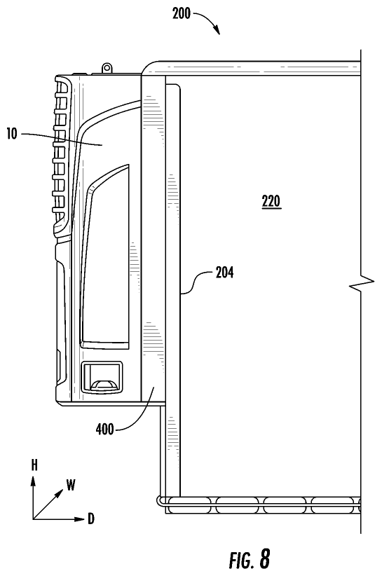

FIG. 8 shows a side view of a TRU 10 and adapter frame 400 installed onto a railway car 200. The adapter frame 400 can be used to position the TRU further away from the railway car 200 and reduce or eliminate the distance of TRU protrusion into the cargo volume 220. By using an adapter frame 400 to mount the TRU to the railway car, the obstructed volume 250 can be reduced or eliminated completely offering a corresponding improvement in available cargo volume 220. The use of an adapter frame 400 allows for ordering the sequence of assembly in the most beneficial way to the installer. The adapter frame 400 can first be installed onto a TRU 10, then the TRU and adapter frame securely mounted to a railway car 200. Or, the adapter frame 400 can first be installed on the railway car 200 then the TRU 10 can be mounted to the adapter frame 400.

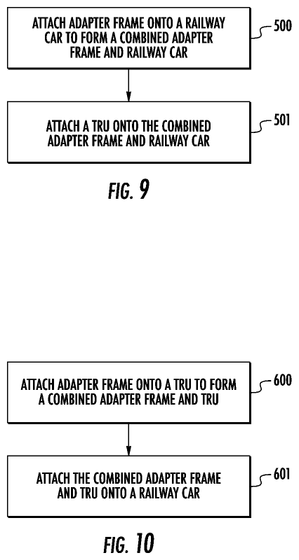

FIG. 9 illustrates an installation method that can be employed using the adapter frame 400. A first step 500 includes attaching an adapter frame 400 onto a railway car 200 to form a combined adapter frame and railway car. The attachment can be made using any suitable fastening method, for example the adapter frame 400 can be welded to the railway car 200, the plurality of railway car side fastening features 411 can be relied on to secure the adapter frame 400 to a wall of a railway car 200. By way of further example, threaded studs extended from the adapter frame 400 could be inserted into corresponding holes in the railway car 200 and nuts fastened thereto to secure the adapter frame 400 to the railway car 200. The TRU 10 can them be installed to the combined adapter frame and railway car in a second step 501 using any suitable fastening method, for example utilizing the TRU car side fastening features 410.

FIG. 10 illustrates an installation method that can be employed using the adapter frame 400. A first step 600 includes attaching an adapter frame 400 to a TRU 10 to form a combined adapter frame and TRU. The attachment can be made using any suitable fastening method, for example the plurality of TRU side fastening features 410 can be relied on to secure the adapter frame 400 and the TRU 10. The combined adapter frame and TRU can then be installed to a railway car 200 in a second step 601 using any suitable fastening method, for example utilizing the railway car side fastening features 411. During and after installation the window 420 of the adapter frame 400 can be aligned with an opening in the wall of the railway car 200.

As part of the installation process the opening 102, the adapter frame 400, the TRU 10, or a combination including at least one of the foregoing can be prepared with a gasket and/or seal material. The gasket and/or seal material can be a unitary structure applied to a side of the adapter frame 400 or the corresponding attachment surface (TRU 10 or railway car 200) prior to assembly in any of steps 500, 501, 600, and/or 601. The gasket and/or seal material can include a fluid material (e.g., silicone caulk) applied before, during, and/or after the assembly in any of steps 500, 501, 600, and/or 601. The gasket and/or seal material can be disposed at least along a portion of the opening 102, one or more sides of the corresponding window 420 in the adapter frame 400, the perimeter of the protruding evaporator section 70, or a combination including at least one of the foregoing. The gasket and/or seal material can include any suitable material. For example, the gasket and/or seal can include a thermal insulation (e.g. fiberglass, cellulose, cork, and the like), a compliant material such as polyethylene, polypropylene, polystyrene, polyvinyl chloride, natural or synthetic rubber, neoprene, nylon, polyacrylonitrile, PVB, silicone, an expanded polymer, extruded polymer, or foamed polymer including at least one of the foregoing, or a combination thereof.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. An adapter frame for attaching a transport refrigeration unit (TRU) to a railway car, the adapter frame comprising:
a window and a supporting section,
the window having a rectangular shape,
the supporting section extending from an edge of the window and comprising two or more truss members spanning from an edge of the window to a corresponding edge of the supporting section,
wherein the adapter frame is configured for installation between the TRU and the railway car such that a distal end of a protruding evaporator section of the TRU protrudes into the window.

2. The adapter frame of claim 1, wherein when installed the distal end of the TRU extends past an interior surface of the railway car wall.

3. The adapter frame of claim 1, wherein when installed the distal end of the TRU is flush with an interior surface of the railway car wall.

4. The adapter frame of claim 1, wherein when installed the distal end of the TRU is does not extend past an interior surface of the railway car wall.

5. The adapter frame of claim 1, further comprising a plurality of fastening features disposed on a surface of the adapter frame.

6. The adapter frame of claim 5, wherein the fastening features comprise a combination of a threaded stud, a captured nut, a slot or opening for accepting a bolt, a weld stud, a flange, a tab, or a combination comprising at least one of the foregoing.

7. The adapter frame of claim 1, further comprising a corner support fastened to a surface of the adapter frame, the corner support extending diagonally between two adjacent structural segments forming a corner.

8. The adapter frame of claim 7, wherein the supporting section has a quadrilateral shape where a width dimension is larger than a height dimension and the corner support extends along a TRU side surface of the adapter frame, adjacent to a corner of the quadrilateral shape, from one side to an adjacent side of the supporting section.

9. The adapter frame of claim 1, wherein the structural segments comprise quadrilateral cross-sectional shape.

10. The adapter frame of claim 1, wherein the window comprises a width of 40 inches to 60 inches, a height of 8 inches to 20 inches.

11. The adapter frame of claim 1, wherein the window comprises a width of 60 inches to 80 inches, a height of 40 inches to 60 inches.

12. The adapter frame of claim 1, wherein the window aligns with an opening in a wall of the railway car.

13. A method of installing a TRU onto a railway car comprising:
attaching an adapter frame onto the TRU using a plurality of fastening features disposed along a surface of the adapter frame to form a combined adapter frame and TRU, and
attaching the combined adapter frame and TRU onto a railway car using a plurality of fastening features disposed along an opposing surface of the adapter frame thereby securing the TRU, adapter frame and railway car together.

14. The method of claim 13 further comprising:
sealing a gap between the TRU and a railway car wall.

15. A method of installing a TRU onto a railway car comprising:
attaching an adapter frame onto the railway car using a plurality of fastening features disposed along a surface of the adapter frame to form a combined adapter frame and railway car, and
attaching the TRU onto the combined adapter frame and railway car using a plurality of fastening features disposed along an opposing surface of the adapter frame thereby securing the TRU, adapter frame and railway car together.

16. The method of claim 15 further comprising:
sealing a gap between the TRU and a railway car wall.
